(19) United States
(12) Patent Application Publication
(10) Pub. No.: US 2014/0068425 A1
(43) Pub. Date: Mar. 6, 2014

(54) SYSTEM AND METHOD OF MODIFYING ORDER AND STRUCTURE OF A TEMPLATE TREE OF A DOCUMENT TYPE BY SPLITTING COMPONENT OF THE TEMPLATE TREE

(71) Applicants: Gururaj Potnis, Bangalore (IN); Mohit Kataria, Bangalore (IN)

(72) Inventors: Gururaj Potnis, Bangalore (IN); Mohit Kataria, Bangalore (IN)

(21) Appl. No.: 13/664,988

(22) Filed: Oct. 31, 2012

(30) Foreign Application Priority Data
Sep. 5, 2012 (IN) 3655/CHE/2012

(51) Int. Cl. G06F 17/30

(52) U.S. Cl. 715/255

(57) ABSTRACT

A document editing tool that allows splitting a primary clause of a document template tree into a first split clause and a second split clause based on a set of instructions is provided. The set of instructions include (a) processing a first selection of the primary clause from the document template tree, (b) replicating the primary clause to obtain a first replicate clause and a second replicate clause, c) deleting a sub-set of content from a content in the first replicate clause to obtain the first split clause, and d) deleting a sub-set of content from a content in the second replicate clause to obtain the second split clause. The document template tree includes one or more parent clauses and one or more child clauses that are arranged hierarchically. The first replicate clause and the second replicate clause include content and a metadata of the primary clause.

### CROSS REFERENCE TO RELATED APPLICATION

This application claims the benefit of Indian Patent Application No. 3655/CHE/2012 filed on Sep. 5, 2012, whereby the contents of the application in its entirety, is herein incorporated by reference.

### BACKGROUND

1. Technical Field

The embodiments herein generally relate to editing a document template tree by changing and/or modifying an order and/or structure of the document template tree to be used for generating an electronic document, and more particularly, editing the document template tree by splitting one or more components of the document template tree such that the coherence, structure and functionality of the document template tree remain intact.

2. Description of the Related Art

Small and large business entities generate several documents like contracts, proposals, correspondence etc. to serve business purposes and capture communication/understanding with customers, vendors, partners, other entities or internal audience. Typically, a text and import of each document in relation to engagement vary with the intended purpose and context of each document. Document creation relies heavily on human memory and past experience of an author who creates the document.

Typically, a new document in a business scenario is created using templates from a library or from precedent documents that were created in similar contexts. For instance, to draft a “Goods Purchase Agreement”, typically a user starts creating the intended document by choosing a standard template of the goods purchase agreement which has been pre-stored as a template file in either a document management system or otherwise stored in folders in one or more formats.

Alternatively, the user chooses a “Goods Purchase Agreement” document that was previously drafted for counter-party as a starting point. Hence the author may have several templates, any of which can be the starting point. Using one such Goods Purchase Agreement template, the user will customize the content based on his/her judgment to suit current context. Further, each template corresponds to its own context when it was prepared and will be required to be changed to suit the current context. For example, a typical template may have one or more clauses and corresponding one or more sub-clauses. Any chosen template will require modification such as deletion, replacement with apt text, and/or addition of new text to the existing clauses and sub-clauses.

The conventional document editing tools do not have the ability, to edit a content of the document template, add a new clause thus formed to the document template and store the new versions of existing clauses and/or sub-clauses in the library as and when they are formed. This is due to the fact that such tools are typically populated with frozen template documents. Once a template is fed into the system, subsequent changes or evolution of better versions of clauses and sub-clauses do not add back to the templates dynamically. Authors are required to begin with the same base template document for every new requirement for the creation of documents of a particular document type.

Because of this inefficiency, users continue to use standard base templates and modify those as required for the context, but this entails extensive manual intervention to complete every document. This makes context specific document editing a costly process, and requiring substantial human intervention. Accordingly there remains a need for a document editing tool that allows creating new document templates specific to a context using an extensive template tree of that document type.

### SUMMARY

In view of the foregoing, an embodiment herein provides a document editing tool that allows splitting a primary clause of a document template tree into a first split clause and a second split clause. The document editing tool includes a memory unit that stores a database and a set of instructions. The database includes a master clause database and one or more document template trees that correspond to one or more document types. The document template tree is selected from the one or more document template trees. The document editing tool further includes a processor that executes the set of instructions. The set of instructions includes (a) processing a first selection of the primary clause from the document template tree. The document template tree includes at least one parent clause and at least one child clause that are arranged hierarchically. (b) replicating the primary clause to obtain a first replicate clause and a second replicate clause. The first replicate clause and the second replicate clause include content and a metadata of the primary clause. c) deleting a sub-set of content from a content in the first replicate clause to obtain the first split clause, and d) deleting a sub-set of content from a content in the second replicate clause to obtain the second split clause. The set of instructions further include e) processing a second selection of at least one of the first split clause and the second split clause, and f) generating an electronic document based on the second selection.

The first split clause and the second split clause may be edited to obtain an edited first split clause and an edited second split clause. Editing the first split clause and the second split clause include editing with reference to at least one of: (i) a gender, (ii) a singular or a plural, (iii) an inclusion of an additional content to substantiate the first split clause and the second split clause. The edited first split clause may be updated as a parent clause in the document template tree and a master clause database by editing the metadata of the primary clause. The edited second split clause may be updated as a parent clause in the document template tree and the master clause database by editing the metadata of the primary clause.

In another embodiment, a method of splitting a primary clause of a document template tree into a first split clause and a second split clause is provided. The method includes (a) processing a first selection of the primary clause from the document template tree that is stored in a master clause database of a database. The document template tree includes one or more parent clauses and one or more child clauses that are arranged hierarchically. The database is stored in a memory unit of a document editing tool. (b) processing by a processor a second selection of a first subset of content from a content of the primary clause, (c) processing a first indication by a input to populate a first blank template tree with the first subset of content, (d) populating the first subset of content from the primary clause into the first blank template tree to obtain the first split clause, (e) processing by the processor a third selection of a second subset of content from the content of the primary clause, (f) processing a second indication by the input unit to populate a second blank template tree with the second subset of content, (g) populating the second subset of content from the primary clause into the second blank template tree to obtain the second split clause, (h) processing a fourth selection of at least one of the first split clause and the second split clause, and (i) generating an electronic document based on the fourth selection.

The second indication to populate includes dragging and dropping the second subset of content from the primary clause into the second blank template tree. The content of (i) the first split clause and (ii) the second split clause may be edited to obtain an edited first split clause and an edited second split clause. Editing of content includes editing with reference to at least one of: (i) a gender, (ii) a singular or a plural, (iii) an inclusion of an additional content to substantiate the edited first split clause and the edited second split clause. The edited first split clause may be updated in the document template tree and a master clause database by creating a metadata for the edited first split clause. The edited second split clause may be updated in the document template tree and the master clause database by creating a metadata for the edited second split clause.

In yet another embodiment, a document editing tool that allows splitting a primary clause of a document template tree into a first split clause and a second split clause is provided. The document editing tool includes (a) a memory unit that stores (i) a set of modules, and (ii) a database that includes a master clause database and one or more document template trees that correspond to a plurality of document types. The document template tree is selected from the one or more document template trees, (b) a display unit that is capable of displaying the one or more document template trees stored in the master clause database, and (c) a processor that executes the set of modules. The set of modules include at least one of (i) a negative split module, and (ii) a positive split module.

The negative split module includes (a) a clause selection module that is capable of processing a first selection of the primary clause from the document template tree, (b) a clause replicating module that is capable of replicating the primary clause into a first replicate clause and a second replicate clause. The first replicate clause and the second replicate clause include a content and a metadata of the primary clause. (c) a content deleting module that is capable of (i) deleting a sub-set of content from a content in the first replicate clause to obtain the first split clause, and (ii) deleting a sub-set of content from a content in the second replicate clause to obtain the second split clause.

The positive split module includes (a) the clause selection module that is capable of (i) processing a second selection of a first subset of content from a content of the primary clause, and (ii) processing a third selection of a second subset of content from the content of the primary clause, (b) a content indication module that is capable of (i) processing a first input including a first indication to populate a first blank template tree with the first subset of content, and (ii) processing a second input including a second indication to populate a second blank template tree with the second subset of content, (c) a clause populating module that is capable of (i) populating the first subset of content into the first blank template tree to obtain the first split clause, and (ii) populating the second subset of content into the second blank template tree to obtain the second split clause.

The set of modules further includes a clause editing module that is capable of editing content of (i) the first split clause to obtain an edited first split clause, and (ii) the second split clause to obtain an edited second split clause. A metadata edit module of the set of modules is capable of processing an input for updating or creating a metadata for the edited first split clause and a metadata for the edited second split clause. A document update module of the set of modules is capable of processing of updating the edited first split clause and the edited second split clause to the document template tree. A clause comparison module of the set of modules is capable of comparing a content and the metadata of the edited first split clause with a content and the metadata of the edited second split clause.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating with a user system to edit content of a clause associated with a document template tree using a document editing tool according to an embodiment herein;

FIG. 2 illustrates an exploded view of the document editing tool of FIG. 1 according to an embodiment herein;

FIG. 3 illustrates an exploded view of the negative split module of FIG. 2 according to an embodiment herein;

FIG. 4 illustrates an exploded view of the positive split module of FIG. 2 according to an embodiment herein;

FIG. 5 illustrates an exemplary view of a document template tree stored in a master clause database of the database of FIG. 2 according to an embodiment herein;

FIG. 6 illustrates an exemplary view of a content associated with one or more child clauses of the annual vacation and general holiday policy of FIG. 5 according to an embodiment herein;

FIG. 7A is flow diagram illustrating a negative split method of splitting a content associated with a primary clause of a document template tree into a first split clause and a second split clause according to an embodiment herein;

FIG. 7B illustrates an exemplary view of splitting the annual vacation and general holiday policy of FIG. 5 into a annual vacation policy and a general holiday policy by a negative method using the negative split module of FIG. 2 according to an embodiment herein;

FIG. 7C illustrates an exemplary view of deleting a content of the first replicate clause and the second replicate clause to obtain the annual vacation policy and the general holiday policy of FIG. 7B according to an embodiment herein;

FIG. 8A is a flow diagram illustrating a positive method of splitting a content associated with a primary clause of a document template tree into a first split clause and a second split clause according to an embodiment herein;

FIG. 8B illustrates an exemplary view of splitting the annual vacation and general holiday policy of FIG. 5 into the annual vacation policy and the general holiday policy by a positive split method using the positive split module of FIG. 2 according to an embodiment herein;

FIG. 8C illustrates an exemplary view of dragging a content of the annual vacation and general holiday policy and dropping it into the first blank template tree to obtain the annual vacation policy of FIG. 8B according to an embodiment herein;

FIG. 8D illustrates an exemplary view of dragging a content of the annual vacation and general holiday policy and dropping it into the second blank template tree to obtain the general holiday policy of FIG. 8B according to an embodiment herein;

FIG. 9A illustrates an exemplary view of a content associated with the annual vacation policy and the general holiday policy of FIG. 7B and FIG. 8B according to an embodiment herein;

FIG. 9B illustrates an exemplary view of an edited annual vacation policy and an edited general holiday policy according to an embodiment herein;

FIG. 10A illustrates an exemplary view of the document template tree of FIG. 5 with the edited annual vacation policy and the edited general holiday policy of FIG. 9B that are updated as a parent clause according to an embodiment herein;

FIG. 10B illustrates an exemplary view of the document template tree of FIG. 5 with the edited annual vacation policy and the edited general holiday policy of FIG. 9B that are updated as a child clause according to an embodiment herein;

FIG. 10C illustrates an exemplary view of the document template tree of FIG. 5 with the edited annual vacation policy that is updated as a parent clause and the edited general holiday policy that is updated as a child clause according to an embodiment herein; and

FIG. 11 illustrates a schematic diagram of a computer architecture according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

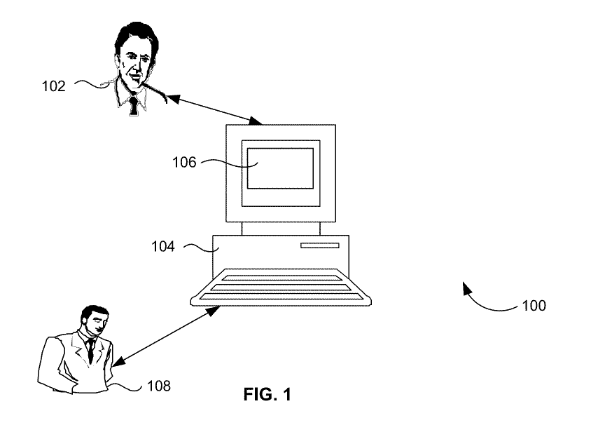

As mentioned, there remains a need for a document editing tool that allows a user to edit content of a document template tree to be used for generating an electronic document by changing and/or modifying an order and/or structure of a document template tree. The embodiments herein achieve this by providing sub-modules of the document editing tool that allows a dynamic structuring of the document template tree. The document template tree is stored in a master clause database of a database. The master clause database includes one or more similar such document template trees that correspond to one or more document types. The dynamic structuring of the document template tree includes splitting a clause of the document template tree into two or more new alternative clauses. Herein throughout description of various embodiments, the term clause refers to a parent clause or a child-clause or a sub-child clause of a document template tree. Similarly, the term alternative clause refers to an alternative parent clause or an alternative child clause or an alternative sub-child clause of a document template tree. Referring now to the drawings, and more particularly to FIGS. 1 through 11, where similar reference characters denote corresponding features consistently throughout the figures, there are shown preferred embodiments.

FIG. 1 illustrates a system view 100 of a user 102 communicating with a user system 104 to edit content of a clause associated with a document template tree using a document editing tool 106 according to an embodiment herein. The document template tree includes one or more parent clauses with corresponding one or more alternative parent clauses. Each parent clause of the document template tree is in turn arranged as a tree that may include one or more child clauses with corresponding one or more alternative child clauses. Similarly, the document template tree may include various levels of clauses (e.g., sub-child clauses, sub-sub-child clauses, etc). The document template tree includes such clauses (e.g., parent clauses, child clauses, and sub-child clauses) that are arranged hierarchically.

Alternative (competing) clauses are the different forms of text of the parent clause, child-clause and/or sub-child-clause with a metadata. The metadata is used to qualify content of the alternative clauses of the document template tree. For each new clause that is formed by editing the document template tree, metadata is formulated. Further, the metadata are of two types such as a subjective metadata and an objective metadata. An addition of the subjective metadata needs assistance of a domain expertise. For example, in the creation of a new document by the drafter 108, the subjective metadata would be what is the risk level associated with each of alternative versions of the clause? Whereas, an addition of the objective metadata does not need any such domain expertise. For example, how many times a particular version of a parent clause from a document template tree was used?

In one embodiment, the user 102 has an authentication to create, add, modify, edit, merge, and/or delete content associated with the clause of the document template tree. A drafter 108 (e.g., an end user, contract drafter), drafts an electronic document using content of the document template tree. This document template tree will prevent loss of relevant information while ensuring better construct of the electronic document. In one embodiment, the drafter 108 may also be a user 102, can have authentication to modify content associated with the clause of the document template tree. The document editing tool 106 includes a memory unit that stores a set of modules, a processor and a database.

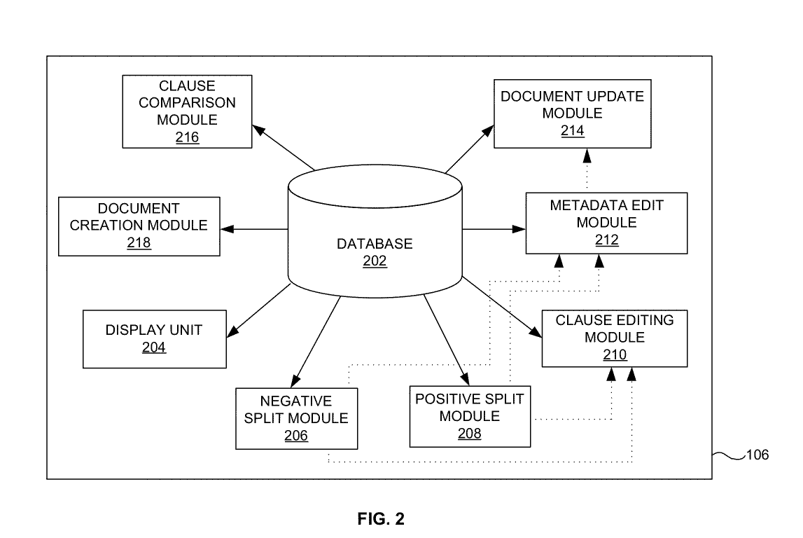

FIG. 2 illustrates an exploded view of the document editing tool 106 of FIG. 1 according to an embodiment herein. The document editing tool 106 includes a memory unit having set of instructions and a database 202, a display unit 204, a negative split module 206, a positive split module 208, a clause editing module 210, a metadata edit module 212, a document update module 214, a clause comparison module 216, and a document creation module 218. The database 202 includes one or more master clause databases (not shown in the FIG. 2) for storing one or more document template tree.

The display module 204 provides a user interface of the one or more document template tree to the user 102 and the drafter 108. The negative split module 206 has one or more sub-modules that allow the user 102 to split a clause of a document template tree into two or more new alternative clauses by a negative method. The positive split module 208 has one or more sub-modules that allow the user 102 to split a clause of a document template tree into two or more new alternative clauses by a positive method. The clause editing module 210 processes a user input for editing a content of each of the two or more new alternative clauses to obtain two or more edited alternative clauses. The metadata edit module 212 processes a user input and allows the user 102 to create a metadata for each of the two or more edited alternative clauses, and/or to edit a metadata of existing alternative clauses. The document update module 214 updates each of the two or more edited alternative clauses to the document template tree and a master clause database. The clause comparison module 216 processes a user input and displays a user interface view of a content and a metadata associated with each of the two or more edited alternative clauses to the user 102 and the drafter 108. The drafter 108 compares the content and the metadata of each of the two or more edited alternative clauses, and includes one or more desired edited alternative clauses in an electronic agreement that needs to be generated using the document creation module 218.

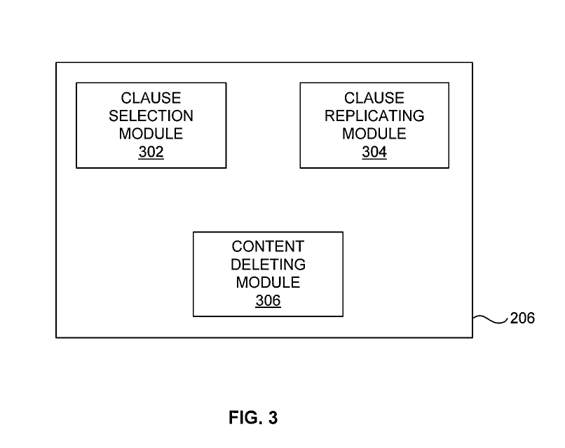

FIG. 3 illustrates an exploded view of the negative split module 206 of FIG. 2 according to an embodiment herein. The negative split module 206 includes a clause selection module 302, a clause replicating module 304, and a content deleting module 306. The clause selection module 302 processes a selection of (i) a document template tree from a master clause database, and (ii) a primary clause from the document template tree. The clause replicating module 304 replicates the primary clause into two or more replicate clauses. The content deleting module 306 processes a user input for deleting a subset of content from a content of each of the two or more replicate clauses.

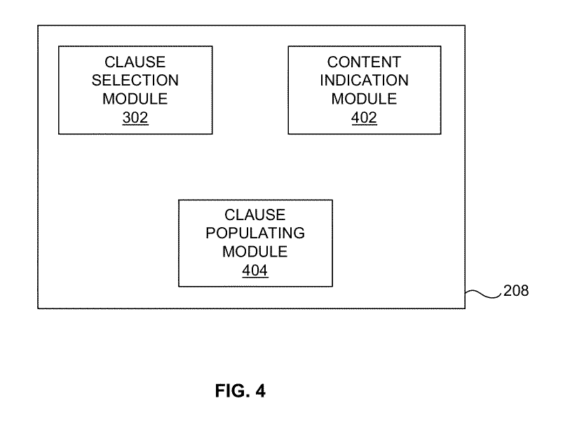

FIG. 4 illustrates an exploded view of the positive split module 208 of FIG. 2 according to an embodiment herein. The positive split module 208 includes the clause selection module 302 of FIG. 3, a content indication module 402, and a clause populating module 404. The clause selection module 302 processes a selection of one or more subset of content from a primary clause of a document template tree. The content indication module 402 processes one or more indication for populating one or more blank template trees with the one or more subset of content to obtain one or more new alternative clauses. The clause populating module 404 populates the one or more subset of content into the one or more blank template trees.

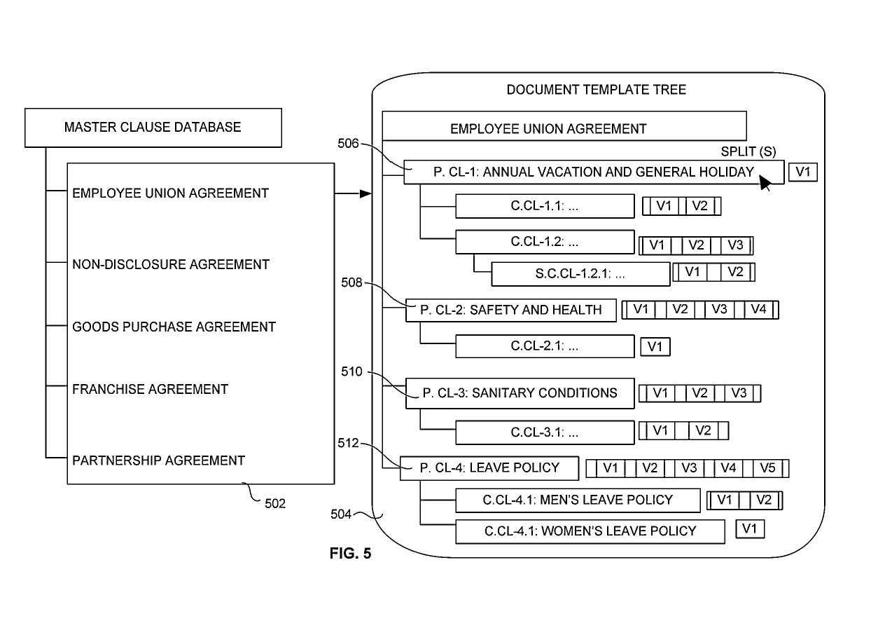

FIG. 5 illustrates an exemplary view of a document template tree 504 stored in a master clause database 502 of the database 202 of FIG. 2 according to an embodiment herein. The master clause database 502 includes one or more document template tree that corresponds to various document types are provided by the user 102. The user 102 selects a document template tree from the one or more document template tree, which he/she needs to edit. For example, when the user 102 selects an agreement (e.g., an employee union agreement) stored in the master clause database 502, clause titles of the employee union agreement (parent clauses titles, child clauses titles, and sub child-clauses titles with corresponding alternative clauses) with their associated content are provided to the user 102 as the document template tree 504. In one embodiment, the drafter 108 drafts the employee union agreement using the document template tree 504. Other similar document template tree that may be stored in the master clause database 502 includes a contract or agreements such as a non-disclosure agreement, a goods purchase agreement, a franchise agreement and/or a partnership agreement, etc.

The user 102 and the drafter 108 may view content associated with the clauses of the document template tree 504 by clicking on titles of the clauses. For example, content associated with the employee union agreement is displayed to the user 102 and the drafter 108 when they click on the clause employee union agreement. The document template tree 504 of the employee union agreement may include various parent clauses such as an annual vacation and general holiday policy 506, a safety and health policy 508, a sanitary conditions policy 510, and a leave policy 512 with their corresponding alternative clauses. The drafter 108 views content associated with the parent clauses, and/or the child clauses in the employee union agreement, and includes one or more desired parent clauses, and/or desired one or more child clauses in an electronic document by clicking on desired clause titles.

The drafter 108 may also compare a content and a metadata associated with one or more alternative clauses (e.g., the sanitary conditions policy 510 has 3 alternative clauses) and includes a desired alternative clause in the electronic document. In one embodiment, the document editing tool 106 provides an option to the user 102 to indicate splitting a clause of a document template tree into one or more new alternative clause by performing a right click on a title of the clause. In another embodiment, the user 102 may also select the clause for splitting by ticking a title of the clause or by inputting a clause number of the clause. The user 102 may split the clause either by a negative split method (using the negative split module 206) or by a positive split method (using the positive split module 208). Therefore, the embodiments herein described for splitting of a clause is performed with either the negative split module 206 or the positive split module 208.

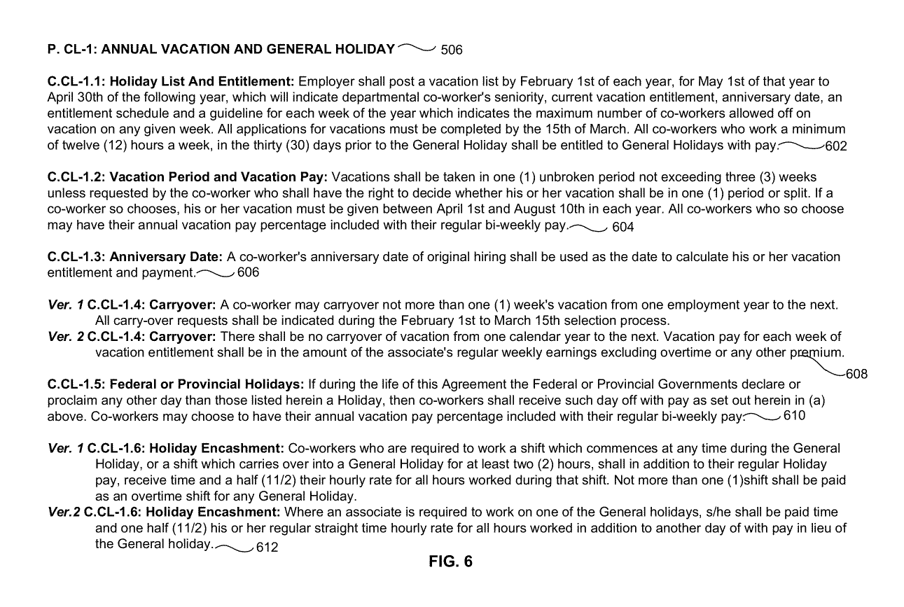

FIG. 6 illustrates an exemplary view of a content associated with one or more child clauses of the annual vacation and general holiday policy 506 of FIG. 5 according to an embodiment herein. The annual vacation and general holiday policy 506 includes child clauses such as a holiday and entitlement policy 602, a vacation period and vacation pay policy 604, an anniversary date policy 606, a carryover policy 608 with two alternative clauses, a federal or provincial holidays policy 610, and a holiday encashment policy 612 with two alternative clauses.

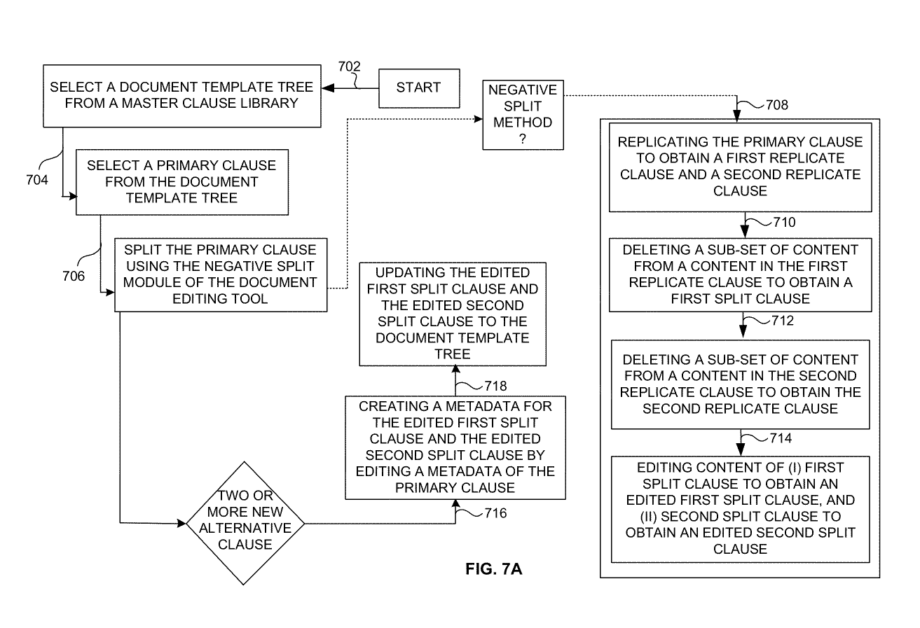

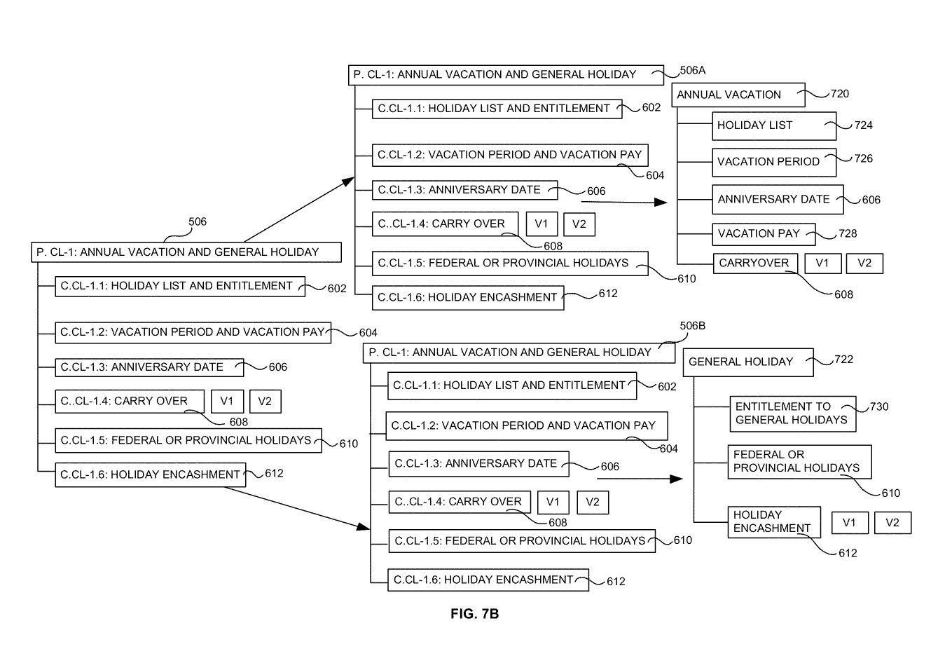

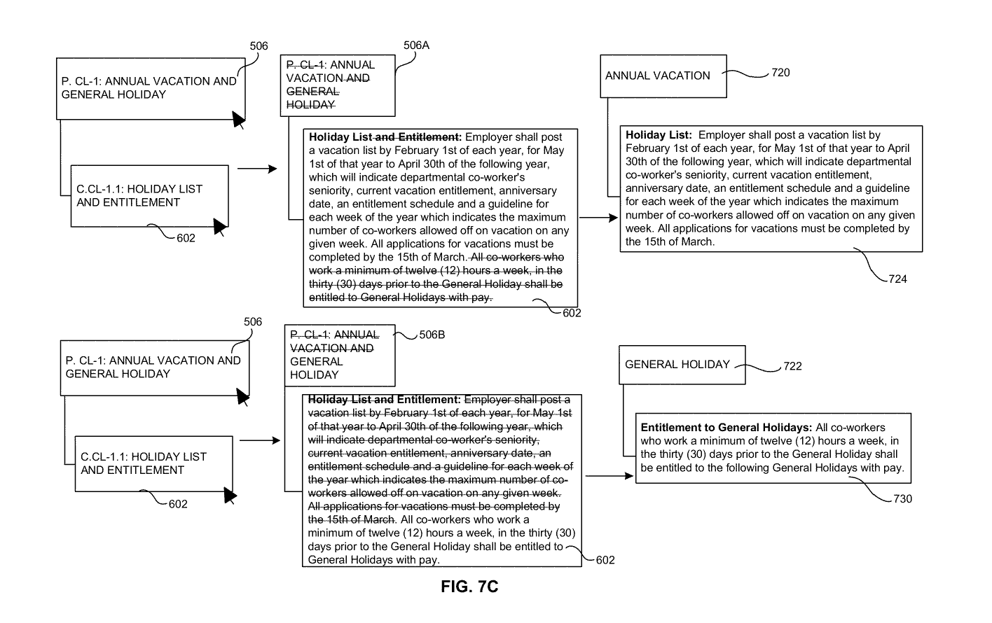

FIG. 7A is flow diagram illustrating a negative split method of splitting a content associated with a primary clause of a document template tree into a first split clause and a second split clause according to an embodiment herein. In step 702, the clause selection module 302 allows the user 102 to select a document template tree from a master clause database of the database 202 of FIG. 2. In step 704, the clause selection module 302 processes a first selection of a primary clause from the document template tree. In one embodiment, the primary clause is a parent clause that includes one or more child clauses arranged as a template tree. In another embodiment, the primary clause is a child clause that is selected from the document template tree. In step 706, a content of the primary clause of the document template tree is split into a first split clause and a second split clause by performing the following steps.

In step 708, the clause replicating module 402 replicates the primary clause into a first replicate clause and a second replicate clause. The first replicate clause and the second replicate clause include a content a metadata of the primary clause. In step 710, the content deleting module 404 deletes a subset of content from a content in the first replicate clause to obtain the first split clause. In step 712, the content deleting module 404 deletes a subset of content from a content in the second replicate clause to obtain the second split clause. In step 714, the clause editing module 210 of FIG. 2 processes a user input for (i) editing a content of the first split clause to obtain an edited first split clause, and (ii) editing a content of the second split clause to obtain an edited second split clause. In step 716, the metadata edit module 212 that processes a user input for creating a metadata for the edited first split clause and a metadata for the edited second split clause by editing the metadata of the primary clause. In step 718, the document update module 214 updates the edited first split clause and the edited second split clause in the document template tree and a master clause database as a parent clause. In one embodiment, the document update module 214 updates the edited first split clause and the edited second split clause in the document template tree and the master clause database as a child clause to a parent clause.

In one embodiment, the clause selection module 302 may process a second selection of the first split clause, and/or the second split clause to include in an electronic document. In another embodiment, the drafter 108 may also include the edited first split clause, and/or the edited second split clause in the electronic document.

FIG. 7B illustrates an exemplary view of splitting the annual vacation and general holiday policy 506 of FIG. 5 into a annual vacation policy 720 and a general holiday policy 722 by a negative method using the negative split module 206 of FIG. 2 according to an embodiment herein. The clause replicating module 304 replicates the annual vacation and general holiday policy 506 into a first replicate clause 506A and a second replicate clause 506B. Both the first replicate clause 506A and the second replicate clause 506B include same content (child clauses) and a metadata of the annual vacation and general holiday policy 506. However, the annual vacation and general holiday policy 506 may also split into more than two clauses. For example, the annual vacation and general holiday policy 506 is split into the annual vacation policy 720, the general holiday policy 722 and a leave policy (not shown in the FIG. 7B) by replicating the annual vacation and general holiday policy 506 into the first replicate clause 506A, the second replicate clause 506B and a third replicate clause 506C (not shown in the FIG. 7B). However, for clear understanding of various embodiments herein, a primary clause is illustrated to split into only two different clauses.

The content deleting module 404 processes a user input for deleting a subset of content from a content of the first replicate clause 506A to obtain the annual vacation policy 720. The annual vacation policy 720 includes one or more child clauses such as a holiday list policy 724, a vacation period policy 726, the anniversary date policy 606, a vacation pay policy 728, and the carryover policy 608. The annual vacation policy 720 includes a content that are related only to a “vacation policy”. Similarly, the content deleting module 404 processes a user input for deleting a subset of content from a content of the second replicate clause 506B to obtain the general holiday policy 722. The general holiday policy 722 includes one or more child clauses such as a entitlement to general holidays policy 730, the federal or provincial holidays policy 610, and the holiday encashment policy 612. The general holiday policy 722 includes a content that are related only to a “holiday policy”.

FIG. 7C illustrates an exemplary view of deleting a content of the first replicate clause 506A and the second replicate clause 506B to obtain the annual vacation policy 720 and the general holiday policy 722 of FIG. 7B according to an embodiment herein. The annual vacation policy 720 is obtained from editing a content of the first blank template tree 506A by: (i) deleting a subset of content from the child clause holiday list and entitlement policy 602 of the first blank template tree 506A by a user input as shown in the FIG. 7C to obtain the child clause holiday list 724 of FIG. 7B, Similarly, (ii) deleting a subset of content from the vacation period and vacation pay policy 604 by a user input to obtain the child clause vacation period policy 726 and the vacation pay policy 728 (not shown in the FIG. 7C), and (iii) deleting child clauses such as the federal or provincial holidays policy 610, and the holiday encashment policy 612 that are related to “holiday policy” from the first blank template tree 506A (not shown in the FIG. 7C) to obtain the annual vacation policy 720.

Similarly, the general holiday policy 722 is obtained from editing a content of the second blank template tree 506B by: (i) deleting a subset of content from the child clause holiday list and entitlement policy 602 of the second blank template tree 506B by a user input as shown in the FIG. 7C to obtain the child clause entitlement to general holiday policy 730 of FIG. 7B, and (ii) deleting child clauses such as the vacation period and vacation pay policy 604, the anniversary date policy 604, and the carryover policy 606 (related to “vacation policy”) to obtain the general holiday policy 722.

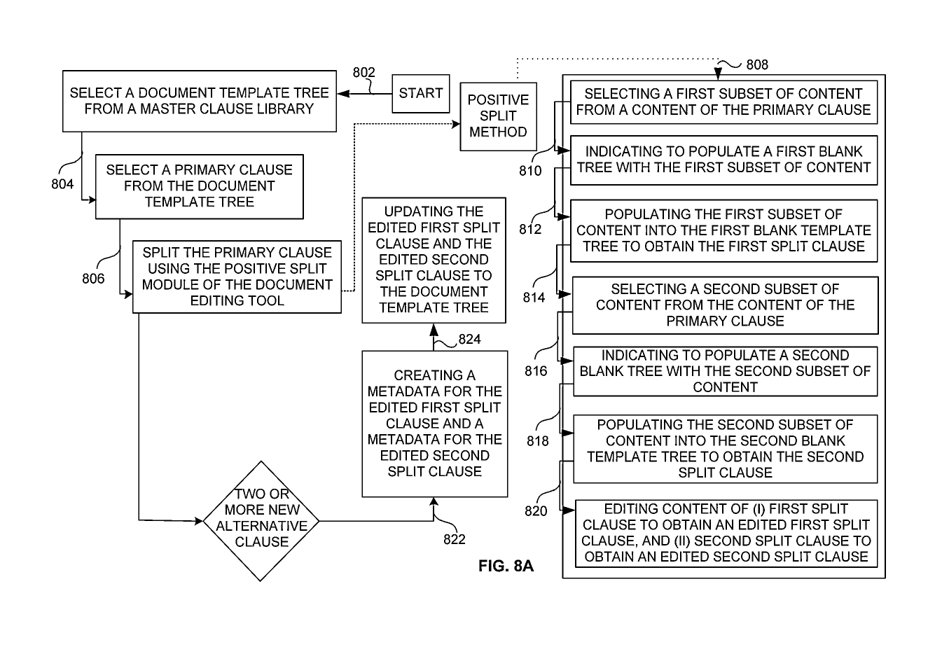

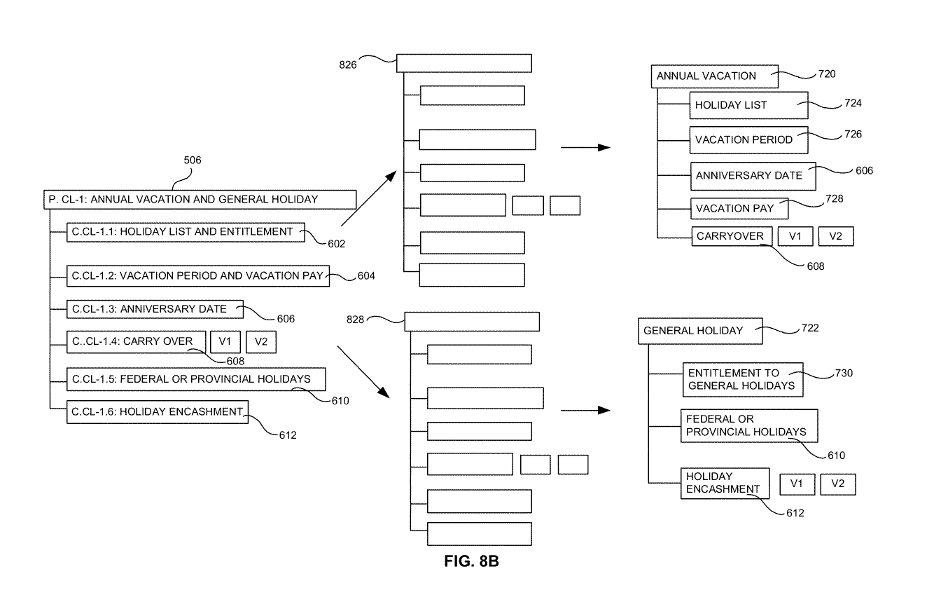

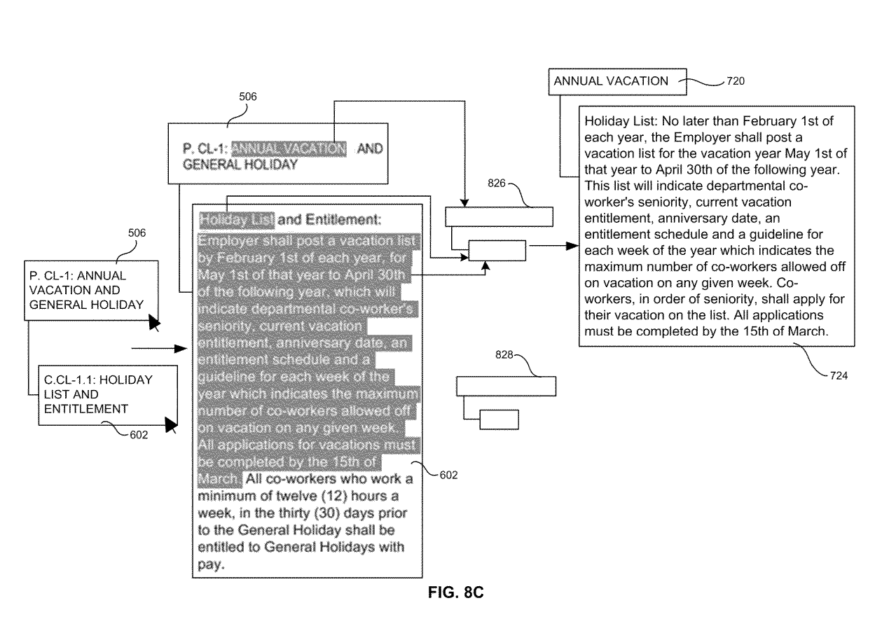

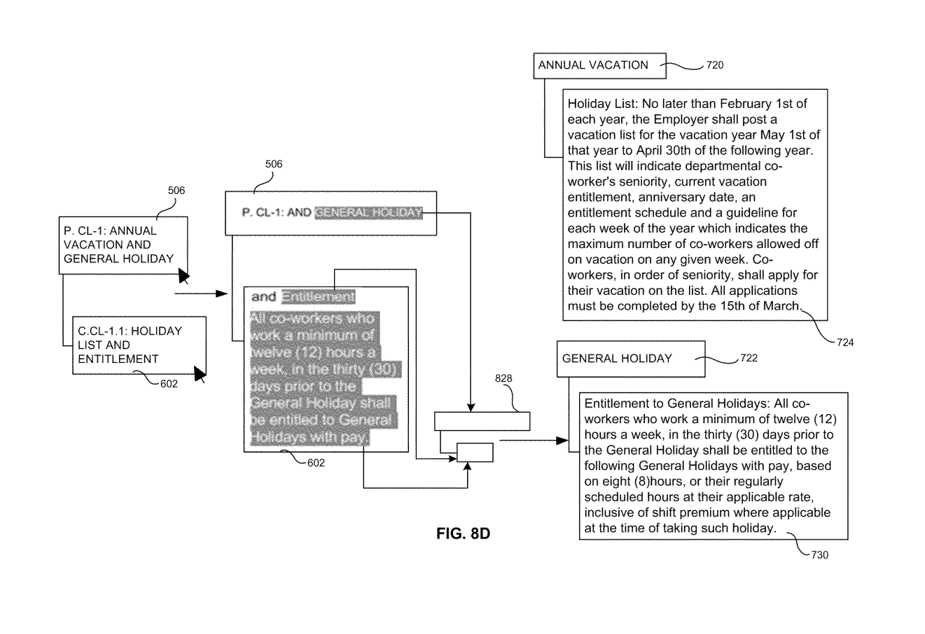

FIG. 8A is a flow diagram illustrating a positive method of splitting a content associated with a primary clause of a document template tree into a first split clause and a second split clause according to an embodiment herein. In step 802, the clause selection module 302 allows the user 102 to select a document template tree from a master clause database of the database 202 of FIG. 2. In step 804, the clause selection module 302 processes a first selection, from a first input unit, of a primary clause from the document template tree. For example, the first input unit includes mouse, keyboard, touch screen, stylus, etc. In one embodiment, the primary clause is a parent clause that includes one or more child clauses arranged as a template tree. In another embodiment, the primary clause is a child clause that is selected from the document template tree. In step 806, a content of the primary clause of the document template tree is split into a first split clause and a second split clause by performing the following steps.

In step 808, a processor of the document editing tool 106 of FIG. 1 executes the clause selection module 302 for a second selection of a first subset of content from a content of the primary clause. In step 810, the content indication module 402 processes a first input by a second input unit includes a first indication to populate a first blank template tree with the first subset of content. For example, the second input unit may be a mouse, keyboard, touch screen, stylus, etc. In one embodiment, the first input unit and the second input unit are same. In another embodiment, the first input unit and the second input unit are different. In step 812, the clause populating module 404 processes a user input to populate the first subset of content into the first blank template tree by dragging the first subset of content and dropping it into the first blank template tree to obtain the first split clause. In step 814, the processor of the document editing tool 106 of FIG. 1 executes the clause selection module 302 processes a third selection of a second subset of content from the content of the primary clause. In step 816, the content indication module 402 processes a second input by the first input unit or the second input unit includes a second indication to populate a second blank template tree with the second subset of content. In step 818, the clause populating module 404 processes a user input to populate the second subset of content into the second blank template tree by dragging the second subset of content and dropping it into the second blank template tree to obtain the second split clause. In step 820, the clause editing module 210 of FIG. 2 processes a user input for editing (i) a content of the first split clause to obtain an edited first split clause and (ii) a content of the second split clause to obtain an edited second split clause. In step 822, the metadata edit module 212 processes a user input to create a metadata for the edited first split clause and a metadata for the edited second split clause. In step 824, the document update module 214 updates the edited first split clause and the edited second split clause in the document template tree and a master clause database. In one embodiment, the clause selection module 302 processes a fourth selection of the first split clause, and/or the second split clause to include in an electronic document. In another embodiment, the drafter 108 may also include the edited first split clause and the edited second split clause into the electronic document.

FIG. 8B illustrates an exemplary view of splitting the annual vacation and general holiday policy 506 of FIG. 5 into the annual vacation policy 720 and the general holiday policy 722 by a positive split method using the positive split module 208 of FIG. 2 according to an embodiment herein. In one embodiment, when the user 102 intents to split the annual vacation and general holiday policy 506 into two new alternative clauses, the document editing tool 106 provides the user 102 a first blank template tree 826 and a second blank template tree 828 on selection of the positive split method. In another embodiment, the user 102 may also split the annual vacation and general holiday policy 506 into more than two new alternative clauses by providing more than two blank template trees. A sub-modules of the positive split module 208 processes (i) a first selection of a first subset of content from a content of the annual vacation and general holiday policy 506 and dropping it into the first blank template tree to obtain the annual vacation policy 720, and (ii) a second selection of a second subset of content from the content of the annual vacation and general holiday policy 506 and dropping it into the second blank template tree to obtain the general holiday policy 722.

FIG. 8C illustrates an exemplary view of dragging a content of the annual vacation and general holiday policy 506 and dropping it into the first blank template tree 826 to obtain the annual vacation policy 720 of FIG. 8B according to an embodiment herein. The clause selection module 302 processes a user input to select a first subset of content from the holiday list and entitlement policy 602 (shown as a selected content in the FIG. 8C). In one embodiment, the user 102 selects an indication to drag the first subset of content and drop it into the first blank template tree 826 of FIG. 8B. The content indication module 402 processes the indication. The clause populating module 404 allows the user 102 to drag the first subset of content and drop it into the first blank template tree 826 to obtain the holiday list policy 724. In addition, (i) a subset of content associated with the vacation period and vacation pay policy 604 is dragged and dropped into the first blank template tree 826 as the child clause vacation period policy 726 and the vacation pay policy 728 (not shown in the FIG. 8C), and (ii) a content of the anniversary date policy 606, and a content of the carryover policy 608 are dragged and dropped into the first blank template tree 826 to obtain the annual vacation policy 720 of FIG. 8B.

FIG. 8D illustrates an exemplary view of dragging a content of the annual vacation and general holiday policy 506 and dropping it into the second blank template tree 828 to obtain the general holiday policy 722 of FIG. 8B according to an embodiment herein. The clause selection module 302 processes a user input to select a second subset of content from the holiday list and entitlement policy 602 (shown as a selected content in the FIG. 8D). In one embodiment, the user 102 selects an indication to drag the second subset of content and drop it into the second blank template tree 828 of FIG. 8B. The content indication module 402 processes the indication. The clause populating module 404 allows the user 102 to drag the second subset of content and drop it into the second blank template tree 828 to obtain the entitlement to general holidays 730. In addition, (i) a content of the federal or provincial holidays policy 610 and a content of the holiday encashment policy 612 are dragged and dropped into the second blank template tree 828 (not shown in the FIG. 8D) to obtain the general holiday policy 722 of FIG. 8B.

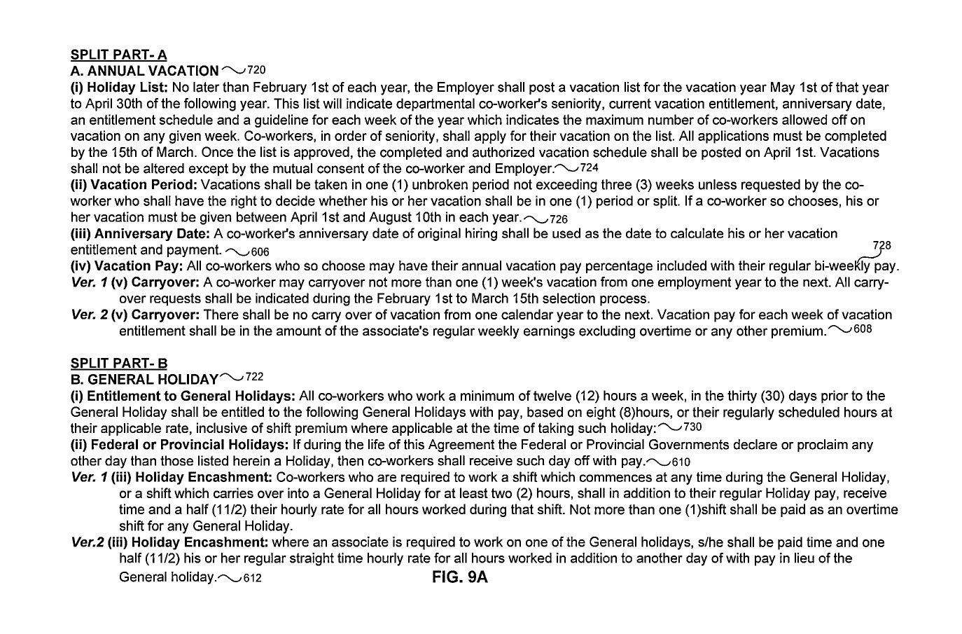

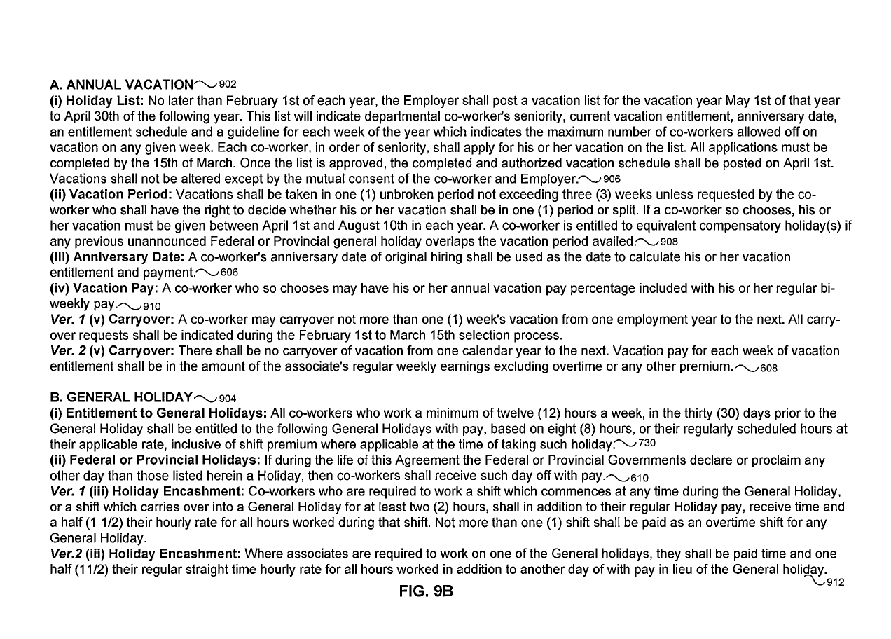

FIG. 9A illustrates an exemplary view of a content associated with the annual vacation policy 720 and the general holiday policy 722 of FIG. 7B and FIG. 8B according to an embodiment herein.

FIG. 9B illustrates an exemplary view of an edited annual vacation policy 902 and an edited general holiday policy 904 according to an embodiment herein. The clause editing module 210 of FIG. 2 processes a user input for editing the content of the annual vacation policy 720 and the general holiday policy 722. The editing includes modifying the content with reference to at least one of: (i) a gender, (ii) a singular or a plural, (iii) an inclusion of an additional content to substantiate the annual vacation policy 720 and the general holiday policy 722. For example, editing with reference to the gender, the singular, and the plural of the content of the annual vacation policy 720 include, the content of the annual vacation policy 720 is provided in a context of a pre-dominant plural (e.g., term “co-workers” in the FIG. 9A) and a pre-dominant neutral gender (e.g., term “their” in the FIG. 9A), that is rephrased to the edited annual vacation policy 902 in a context of a singular (e.g., term “co-worker” in the FIG. 9B) and a differentiated gender (e.g., term “his or her” in the FIG. 9B).

In addition, editing with reference to inclusion of the additional content includes adding an additional content (e.g., “A co-worker is entitled to equivalent compensatory holiday(s) if any previous unannounced federal or provincial general holiday overlaps the vacation period availed”) to the vacation period policy 726 of the annual vacation policy 720 of FIG. 9A to obtain and substantiate the edited annual vacation policy 902. The edited annual vacation policy 902 includes an edited holiday list policy 906, an edited vacation period policy 908, the anniversary date policy 606 of FIG. 6, an edited vacation pay policy 910, and the carryover policy 608 of FIG. 6.

Similarly, the general holiday policy 722 of FIG. 9A is modified to the edited general holiday policy 904. The edited general holiday policy 904 includes the entitlement to general holidays policy 730 of FIG. 7B and FIG. 8B, the federal or provincial holidays policy 610 of FIG. 6, and an edited holiday encashment policy 912.

The metadata edit module 212 processes a user input for creating or editing (i) a metadata for the edited annual vacation policy 902 and (ii) a metadata for the edited general holiday policy 904. The document update module 214 updates the edited annual vacation policy 902 and the edited general holiday policy 904 as a parent clause or as a child clause to the document template tree 304 of FIG. 3.

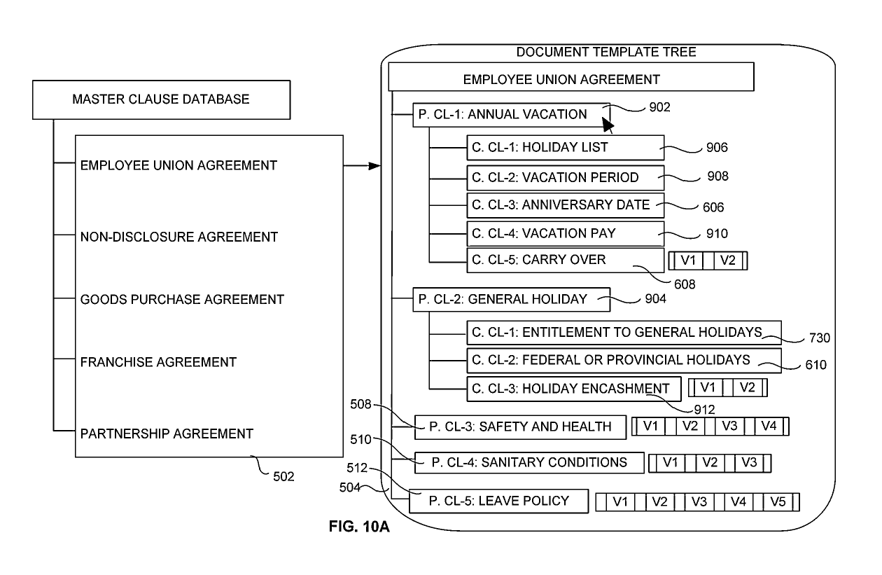

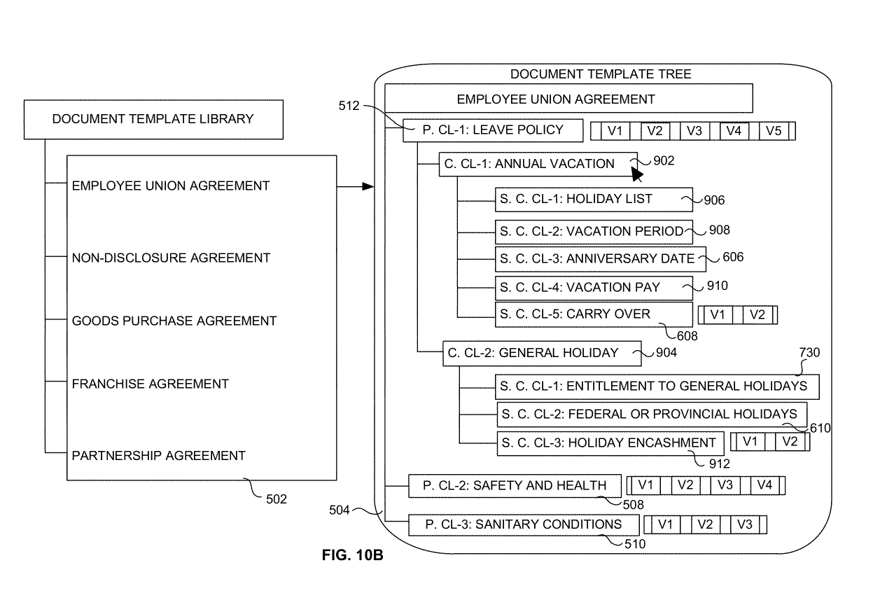

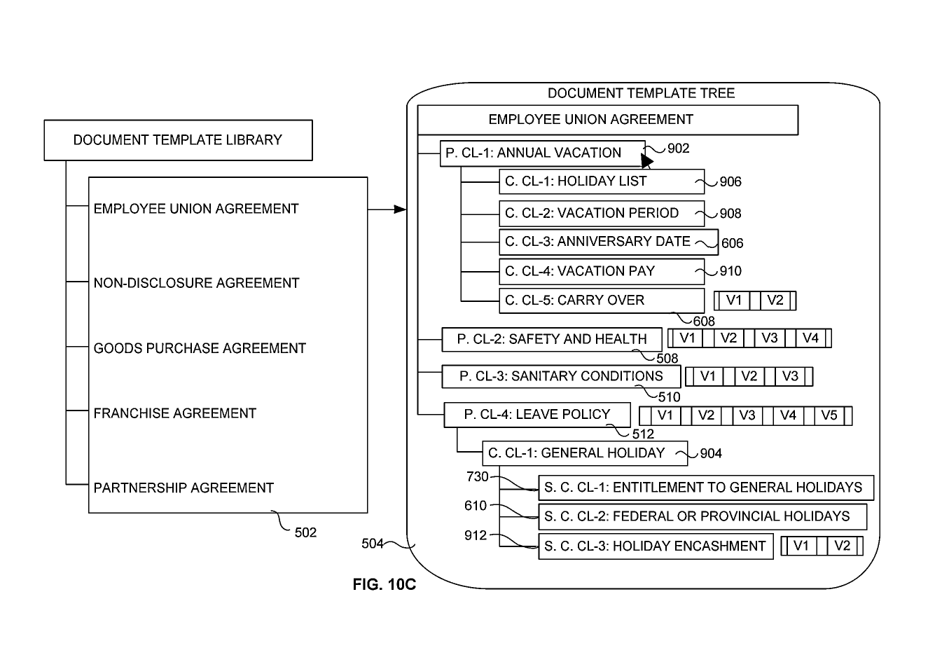

FIG. 10A illustrates an exemplary view of the document template tree 504 of FIG. 5 with the edited annual vacation policy 902 and the edited general holiday policy 904 of FIG. 9B that are updated as a parent clause according to an embodiment herein. The document template tree 504 with a primary clause (e.g., the annual vacation and general holiday policy 506) is split into a first split clause (e.g., the edited annual vacation policy 902) and a second split clause (e.g., the edited general holiday policy 440). In one embodiment, both the edited annual vacation policy 902 and the edited general holiday policy 904 are updated back to the document template tree 504 as parent clause as shown in the FIG. 10A.

FIG. 10B illustrates an exemplary view of the document template tree 504 of FIG. 5 with the edited annual vacation policy 902 and the edited general holiday policy 904 of FIG. 9B that are updated as a child clause according to an embodiment herein.

FIG. 10C illustrates an exemplary view of the document template tree 504 of FIG. 5 with the edited annual vacation policy 902 that is updated as a parent clause and the edited general holiday policy 904 that is updated as a child clause according to an embodiment herein.

The clause comparison module 216 of FIG. 2 processes a user input for comparing the content and a metadata associated with the edited annual vacation policy 902, to the content and a metadata associated with the edited general holiday policy 904. Using, the document creation module of FIG. 2, the drafter 108 includes the edited annual vacation policy 902, and/or the edited general holiday policy 904 to an electronic document that needs to be generated.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor. The embodiments herein may include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

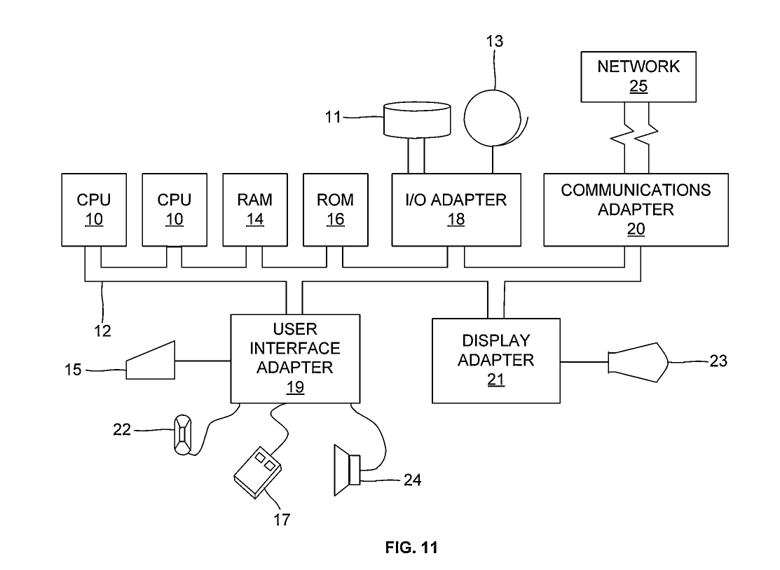

A representative hardware environment for practicing the embodiments herein is depicted in FIG. 11. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A document editing tool that allows splitting a primary clause of a document template tree into a first split clause and a second split clause, said document editing tool comprising:
a memory unit that stores a database and a set of instructions, wherein said database comprises a master clause database and a plurality of document template trees that correspond to a plurality of document types, wherein said document template tree is selected from said plurality of document template trees;
a processor that executes said set of instructions, wherein said set of instructions comprises:
processing a first selection of said primary clause from said document template tree, wherein said document template tree comprises at least one parent clause and at least one child clause that are arranged hierarchically;
replicating said primary clause to obtain a first replicate clause and a second replicate clause, wherein said first replicate clause and said second replicate clause comprise a content and a metadata of said primary clause;
deleting a sub-set of content from a content in said first replicate clause to obtain said first split clause; and
deleting a sub-set of content from a content in said second replicate clause to obtain said second split clause.

2. The document editing tool of claim 1, wherein said set of instructions further comprise:
processing a second selection of at least one of said first split clause and said second split clause; and
generating said electronic document based on said second selection.

3. The document editing tool of claim 1, wherein said set of instructions further comprise editing content of (i) said first split clause and (ii) said second split clause to obtain an edited first split clause and an edited second split clause.

4. The document editing tool of claim 3, wherein said editing comprises editing with reference to at least one of: (i) a gender, (ii) a singular or a plural, (iii) an inclusion of an additional content to substantiate said first split clause and said second split clause.

5. The document editing tool claim 3, wherein said set of instructions further comprise updating said edited first split clause as a parent clause in said document template tree and a master clause database by editing said metadata of said primary clause.

6. The document editing tool of claim 3, wherein said set of instructions further comprise updating said edited second split clause as a parent clause in said document template tree and said master clause database by editing said metadata of said primary clause.

7. A method of splitting a primary clause of a document template tree into a first split clause and a second split clause, said method comprising:
processing a first selection, from an input unit, of said primary clause from said document template tree that is stored in a master clause database of a database, wherein said document template tree comprises at least one parent clause and at least one child clause that are arranged hierarchically, wherein said database is stored in a memory unit of a document editing tool;
processing by a processor a second selection of a first subset of content from a content of said primary clause;
processing a first indication by said input unit to populate a first blank template tree with said first subset of content;
populating said first subset of content from said primary clause into said first blank template tree to obtain said first split clause;
processing by said processor a third selection of a second subset of content from said content of said primary clause;
processing a second indication by said input unit to populate a second blank template tree with said second subset of content; and
populating said second subset of content from said primary clause into said second blank template tree to obtain said second split clause.

8. The method of claim 7, further comprising:
processing a fourth selection of at least one of said first split clause and said second split clause; and
generating an electronic document based on said fourth selection.

9. The method of claim 7, wherein said first indication to populate comprises dragging and dropping said first subset of content from said primary clause into said first blank template tree.

10. The method of claim 7, wherein said second indication to populate comprises dragging and dropping said second subset of content from said primary clause into said second blank template tree.

11. The method of claim 7, further comprising editing content of (i) said first split clause and (ii) said second split clause to obtain an edited first split clause and an edited second split clause.

12. The method of claim 11, wherein said editing comprises editing with reference to at least one of: (i) a gender, (ii) a singular or a plural, (iii) an inclusion of an additional content to substantiate said edited first split clause and said edited second split clause.

13. The method of claim 12, further comprising updating said edited first split clause in said document template tree and a master clause database by creating a metadata for said edited first split clause.

14. The method of claim 12, further comprising updating said edited second split clause in said document template tree and said master clause database by creating a metadata for said edited second split clause.

15. A document editing tool that allows splitting a primary clause of a document template tree into a first split clause and a second split clause, said document editing tool comprising:
a memory unit that stores (i) a set of modules, and (ii) a database that comprises a master clause database and a plurality of document template trees that correspond to a plurality of document types, wherein said document template tree is selected from said plurality of document template trees;
a display unit that is capable of displaying said plurality of document template trees stored in said master clause database; and
a processor that executes said set of modules, wherein said set of modules comprises at least one of:
(i) a negative split module that comprises:
a clause selection module that is capable of processing a first selection of said primary clause from said document template tree;
a clause replicating module that is capable of replicating said primary clause into a first replicate clause and a second replicate clause, wherein said first replicate clause and said second replicate clause comprise a content and a metadata of said primary clause;
a content deleting module that is capable of
(i) deleting a sub-set of content from a content in said first replicate clause to obtain said first split clause; and
(ii) deleting a sub-set of content from a content in said second replicate clause to obtain said second split clause,
(ii) a positive split module that comprises:
said clause selection module that is capable of
(i) processing a second selection of a first subset of content from a content of said primary clause; and
(ii) processing a third selection of a second subset of content from said content of said primary clause,
a content indication module that is capable of
(i) processing a first input comprising a first indication to populate a first blank template tree with said first subset of content; and
(ii) processing a second input comprising a second indication to populate a second blank template tree with said second subset of content, and
a clause populating module that is capable of
(i) populating said first subset of content into said first blank template tree to obtain said first split clause; and
(ii) populating said second subset of content into said second blank template tree to obtain said second split clause.

16. The document editing tool of claim 15, wherein said set of modules further comprises a clause editing module that is capable of editing content of (i) said first split clause to obtain an edited first split clause, and (ii) said second split clause to obtain an edited second split clause.

17. The document editing tool of claim 15, wherein said set of modules further comprises a metadata edit module that is capable of processing an input for updating or creating a metadata for said edited first split clause and a metadata for said edited second split clause.

18. The document editing tool of claim 15, wherein said set of modules further comprises a document update module that is capable of processing of updating said edited first split clause and said edited second split clause to said document template tree.

19. The document editing tool of claim 16, wherein said set of modules further comprises a clause comparison module that is capable of comparing a content and said metadata of said edited first split clause with a content and said metadata of said edited second split clause.
